(19) United States
(12) Patent Application Publication
(10) Pub. No.: US 2026/0203645 A1
(43) Pub. Date: Jul. 16, 2026

(54) AGGREGATING WEIGHT UPDATES TO A MODEL BASED ON AN EVALUATION OF DATA SOURCES

(71) Applicant: Dell Products L.P., Round Rock, TX (US)

(72) Inventors: Zijia Wang, London (GB); Mustafa AlBado, Cork (IE); Srinath Kappgal, Cork (IE)

(21) Appl. No.: 19/019,394

(22) Filed: Jan. 13, 2025

(51) Int. Cl. G06N 20/00

(52) U.S. Cl. CPC G06N 20/00

(57) ABSTRACT

The technologies described herein are generally directed to adjusting a magnitude gradient of a weight update based on the source of the data. For instance, a system can identify first training data from a first node and second training data from a second node. The system may further include assigning respective trust scores to analyzed nodes that include the first node and the second node. Further, the system may include, based on the respective trust scores, adjusting a first weight contribution of the first training data and a second weight contribution of the second training data, as input to training a model.

### BACKGROUND

Decentralized model training may allow data from multiple nodes to collaboratively train models while maintaining data privacy by keeping data local. When training models using diverse data sources, data trustworthiness may be a significant consideration.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include identifying first training data from a first node and second training data from a second node. The method may further include assigning respective trust scores to analyzed nodes that include the first node and the second node. Further, the method may include, based on the respective trust scores, adjusting a first weight contribution of the first training data and a second weight contribution of the second training data, as input to training a model.

Additionally or alternatively, a first trust score of the first node may indicate a lower trust level than a second trust score of the second node, and, based on the lower trust level of the first node, the first weight contribution of the first node may be generated to be less than the second weight contribution of the second node. Additionally or alternatively, the assigning of the respective trust scores may be based on respective historical reliabilities and respective consistencies of the analyzed nodes respectively determined according to a reliability criterion and a consistency criterion. Additionally or alternatively, the assigning of the respective trust scores may be based on respective likelihoods of the analyzed nodes of being a compromised node.

Additionally or alternatively, the assigning of the respective trust scores may be based on respective comparisons of the analyzed nodes to a trusted node. Additionally or alternatively, the adjusting of the respective weight contributions may include suppressing respective contributions of respective training data from the analyzed nodes based on the respective trust scores assigned to the analyzed nodes. Additionally or alternatively, the first training data may include a first weight value determined by the first node, and the first weight contribution of the first node may include a magnitude of change to the model based on the first weight value.

Additionally or alternatively, the method may further include comparing, by the system, the first weight value of the first node to a second weight value of the second node, which may result in a weight value comparison. Additionally or alternatively, the method may further include adjusting the first weight contribution of the first training data based on the weight value comparison. Additionally or alternatively, the weight value comparison may include a level of similarity of the first weight value to the second weight value determined according to a similarity criterion.

Additionally or alternatively, the second node may include a different trust score than the first node, with the first weight value and the second weight value including at least a threshold level of similarity. Additionally or alternatively, the adjusting of the first weight contribution may include changing the first weight contribution based on at least the threshold level of similarity and the different trust score of the second node. Additionally or alternatively, the method may further include determining, by the system, the level of similarity comprising obtaining the level of similarity from a manual remediation process. Additionally or alternatively, the adjusting of the respective weight contributions may include adjusting the respective weight contributions based on a layer-wise normalization of the respective weight contributions. Additionally or alternatively, the assigning of the respective trust scores to the analyzed nodes may include evaluating previously assigned trust scores of the analyzed nodes.

An example system can operate as follows. At least one memory may store computer executable instructions, and at least one processor may be configured to process the computer executable instructions that, when executed by the at least one processor, facilitate performance of operations. The operations may include receiving, from respective training data sources, respective weight adjustment data representative of respective weight adjustments applicable to respective training data from the respective training data sources. The operations may further include determining respective gradient magnitude data representative of respective gradient magnitudes for the respective weight adjustments based on respective assessed reliabilities of the respective training data sources, and the respective weight adjustment data, based on a comparison to other weight adjustment data. Further, the method may include, based on the respective gradient magnitudes, training a machine learning model.

Additionally or alternatively, the operations may further include performing a layer by layer rescaling of the respective gradient magnitudes. Additionally or alternatively, the respective gradient magnitudes of the respective weight adjustment data are based on the respective assessed reliabilities of the respective training data sources. Additionally or alternatively, the respective assessed reliabilities of the respective training data sources are based on a comparison of respective datasets of the training data sources based on a trust criterion, with the trust criterion being derived from analysis of a trusted data source.

An example non-transitory machine-readable medium may include executable instructions that, when executed by at least one processor, facilitate performance of operations. The operations may include receiving iterative adjustments applicable to respective data sources, with the iterative adjustments being generated by the respective data sources based on an analysis of raw data by the respective data sources. The operations may further include assigning respective historic reliability scores to the respective data sources. Further, the operations may include, based on the respective historic reliability scores, communicating to a model training system, federated parameter activations based on the iterative adjustments, with the federated parameter activations being usable by the model training system to adjust respective weight values incorporated in an artificial intelligence data structure.

Additionally or alternatively, the federated parameter activations may be determined based on the respective historic reliability scores of the respective data sources, and respective measures of heterogeneity of the iterative adjustments. Additionally or alternatively, the federated parameter activations may have been determined based on a normalization of the iterative adjustments.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate adjusting a magnitude gradient of a weight update based on the source of the data, in accordance with one or more embodiments;

FIG. 2 is an architecture diagram of an example system that can facilitate adjusting a magnitude gradient of a weight update based on the source of the data, in accordance with one or more embodiments;

FIG. 3 includes a diagram that illustrates aspects of example system that can facilitate adjusting a magnitude gradient of a weight update based on the source of the data, in accordance with one or more embodiments;

FIG. 4 includes a diagram that illustrates aspects of example system that can facilitate adjusting a magnitude gradient of a weight update based on the source of the data, in accordance with one or more embodiments;

FIG. 5 includes a diagram that illustrates aspects of example system that can facilitate adjusting a magnitude gradient of a weight update based on the source of the data, in accordance with one or more embodiments;

FIG. 6 depicts a flow diagram representing example operations of an example method 600 that can facilitate adjusting a magnitude gradient of a weight update based on the source of the data, in accordance with one or more embodiments;

FIG. 7 depicts an example system that can facilitate adjusting a magnitude gradient of a weight update based on the source of the data, in accordance with one or more embodiments;

FIG. 8 depicts an example 800 non-transitory machine-readable medium that can include executable instructions that, when executed by a processor of a system, can facilitate adjusting a magnitude gradient of a weight update based on the source of the data, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the security, data integrity, performance, efficiency, and management of machine learning systems can be improved, e.g., by providing approaches that can affect how training updates from multiple data sources are evaluated and utilized. Particularly, in federated learning systems that aggregate independent, decentralized and diverse data sources, embodiments can improve model stability, reduce the likelihood of successful poisoning attacks, prevent inconsistent updates, and avoid other occurrences that can compromise model integrity, degrade performance, and expose security vulnerabilities. One or more embodiments described herein are not abstract concepts; rather, they provide technical solutions to technical problems associated with the creation, maintenance, and use of machine learning models in computer systems, e.g., providing technical solutions to technical problems that are inextricably tied to computer systems. For example, generally speaking, one or more embodiments may improve the handling of training data/training updates from multiple data sources. Moreover, implementations described herein can provide these solutions in a manner that cannot reliably be performed by a human or even a plurality of humans, e.g., solutions provided may be used with complex and continuous adjustments to machine learning models.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, one or more embodiments described herein can provide a federated learning framework having an aggregation protocol that prioritizes security, trust adaptability, and operational efficiency for model training using decentralized and diverse data sources.

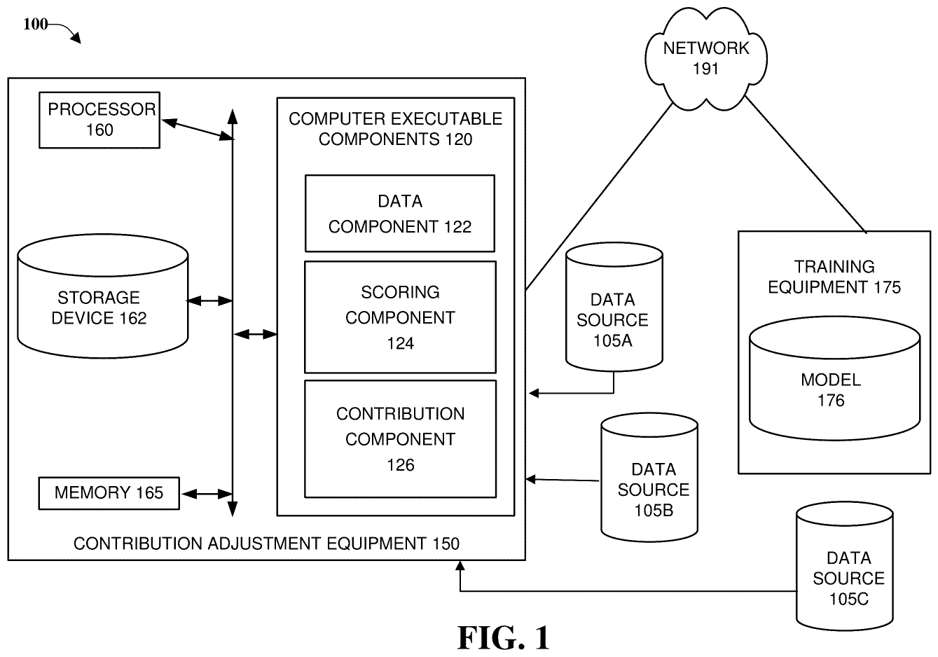

FIG. 1 is an architecture diagram of an example system 100 that can facilitate adjusting a magnitude gradient of a weight update based on the source of the data, in accordance with one or more embodiments. For purposes of brevity, description of like elements and/or processes employed in other embodiments is omitted. As depicted, system 100 includes data sources 105A-C (also termed federated data sources, nodes, and data nodes herein), contribution adjustment equipment 150 connected, via network 191, to training equipment 175. Training equipment 175 includes model 176, which may also be termed herein, an artificial intelligence data structure, and a machine learning model.

As depicted, contribution adjustment equipment 150 can include memory 165 that can store one or more computer and/or machine readable, writable, and/or executable components 120 and/or instructions. In embodiments, contribution adjustment equipment 150 can further include processor 160. In one or more embodiments, computer executable components 120, when executed by processor 160, can facilitate performance of operations defined by the executable component(s) and/or instruction(s). Computer executable components 120 can include data component 122, scoring component 124, contribution component 126, and other components described or suggested by different embodiments described herein, that can improve the operation of system 100. Contribution adjustment equipment 150 may further include storage device 162. In an example, storage device 162 may provide nonvolatile storage of data, data structures, computer executable instructions, and so forth.

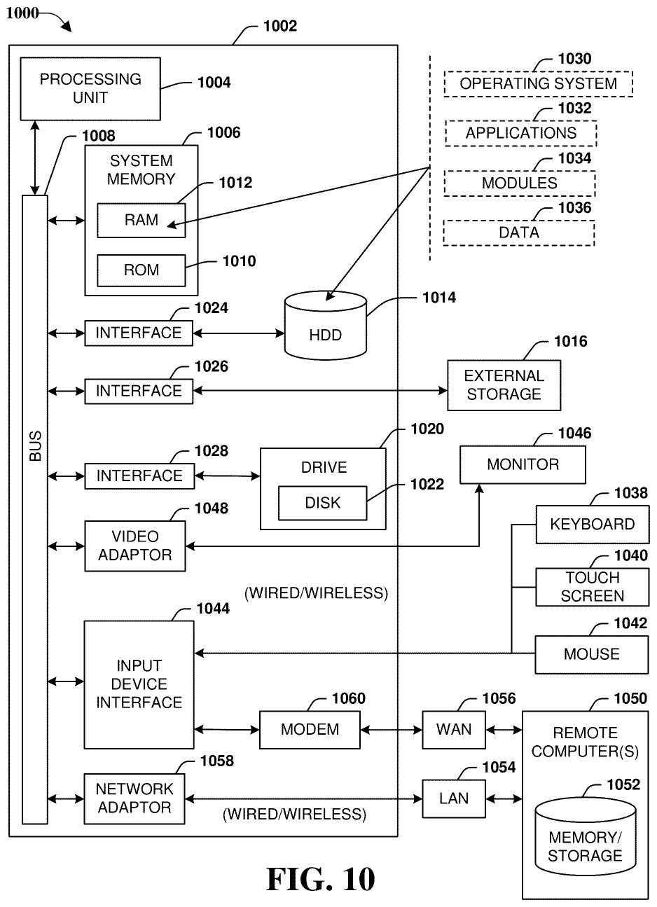

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of data component 122, which can in some implementations can identify first training data from a first node and second training data from a second node. For example, in one or more embodiments, data component 122 may identify data source 105A and data source 105B.

In another example, memory 165 can store executable instructions that can facilitate generation of scoring component 124, which in some implementations may assign respective trust scores to analyzed nodes that include the first node and the second node. For example, in one or more embodiments, scoring component 124 can assign respective trust scores to data source 105A and data source 105B.

In another example, memory 165 can store executable instructions that can facilitate generation of contribution component 126, which in some implementations may, based on the respective trust scores, adjusting a first weight contribution of the first training data and a second weight contribution of the second training data, as input to training a model. For example, in one or more embodiments, contribution component 126 may, based on the respective trust scores, adjusting a first weight contribution of training data from data source 105A and a second weight contribution from data source 105B, as input to training model 176 by training equipment 175. As used herein, weight contributions may also be termed weight adjustment data, weight adjustments, parameter activations, and iterative adjustments.

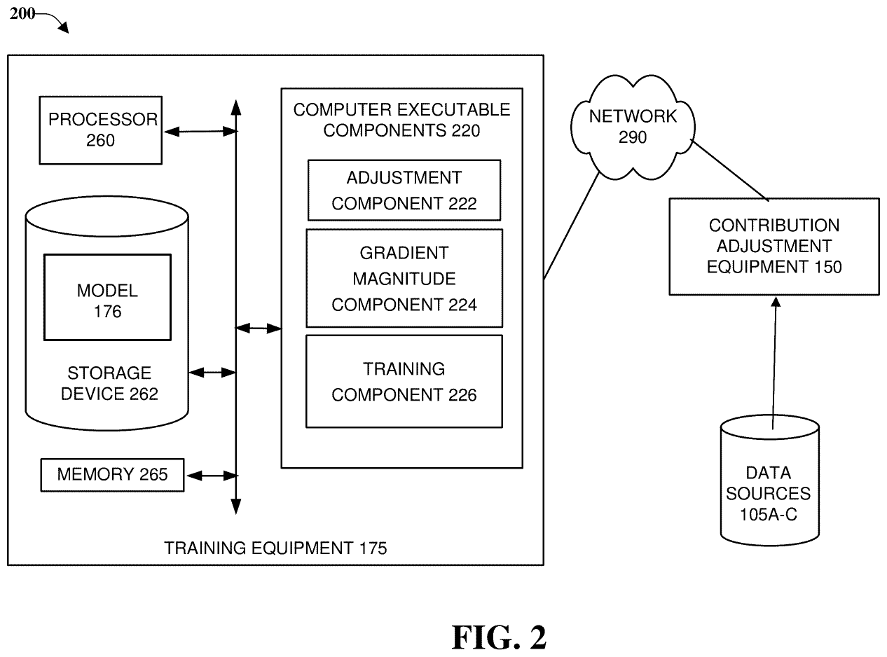

FIG. 2 is an architecture diagram of an example system 200 that can facilitate adjusting a magnitude gradient of a weight update based on the source of the data, in accordance with one or more embodiments. For purposes of brevity, description of like elements and/or processes employed in other embodiments is omitted. As depicted, system 200 includes data sources 105A-C, training equipment 175 connected, via network 290, to contribution adjustment equipment 150. Training equipment 175 includes processor 260, memory 265, storage device 262 including model 176, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include adjustment component 222, gradient magnitude component 224, training component 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2 ) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of training equipment 175, memory 265 can store executable instructions that can facilitate generation of adjustment component 222, which in some implementations, may receive, from respective training data sources, respective weight adjustment data representative of respective weight adjustments applicable to respective training data from the respective training data sources. For example, in one or more embodiments, adjustment component 222 may receive, from data sources 105A-B, respective weight adjustment data representative of respective weight adjustments applicable to training model 176.

In an example implementation of training equipment 175, memory 265 can further store executable instructions that can facilitate generation of gradient magnitude component 224, which in some implementations, may determine respective gradient magnitude data representative of respective gradient magnitudes for the respective weight adjustments based on respective assessed reliabilities of the respective training data sources, and the respective weight adjustment data, based on a comparison to other weight adjustment data. For example, in one or more embodiments, gradient magnitude component 224 may determine respective gradient magnitude data representative of respective gradient magnitudes for the respective weight adjustments based on respective assessed reliabilities of data sources 105A-B, and the respective weight adjustment data, based on a comparison to other weight adjustment data, e.g., data source 105A may be evaluated based on a comparison to data source 105B-C.

In an example implementation of training equipment 175, memory 265 can further store executable instructions that can facilitate generation of training component 226, which in some implementations, may, based on the respective gradient magnitudes, train a machine learning model. For example, in one or more embodiments, training component 226 may, based on the respective gradient magnitudes, train model 176.

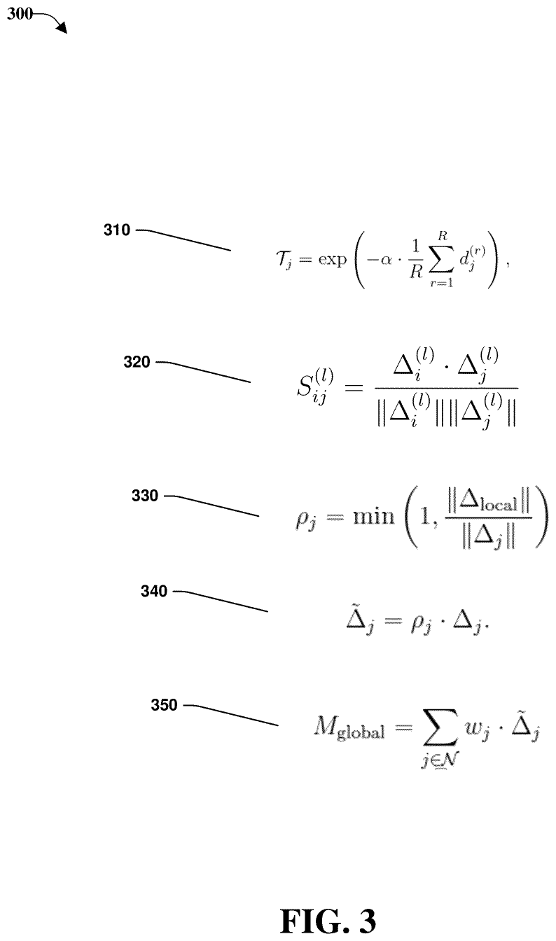

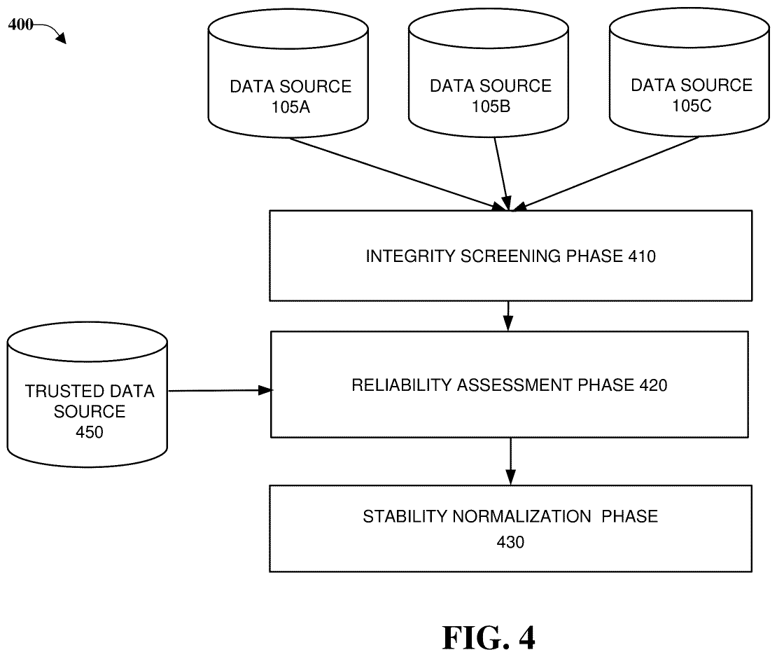

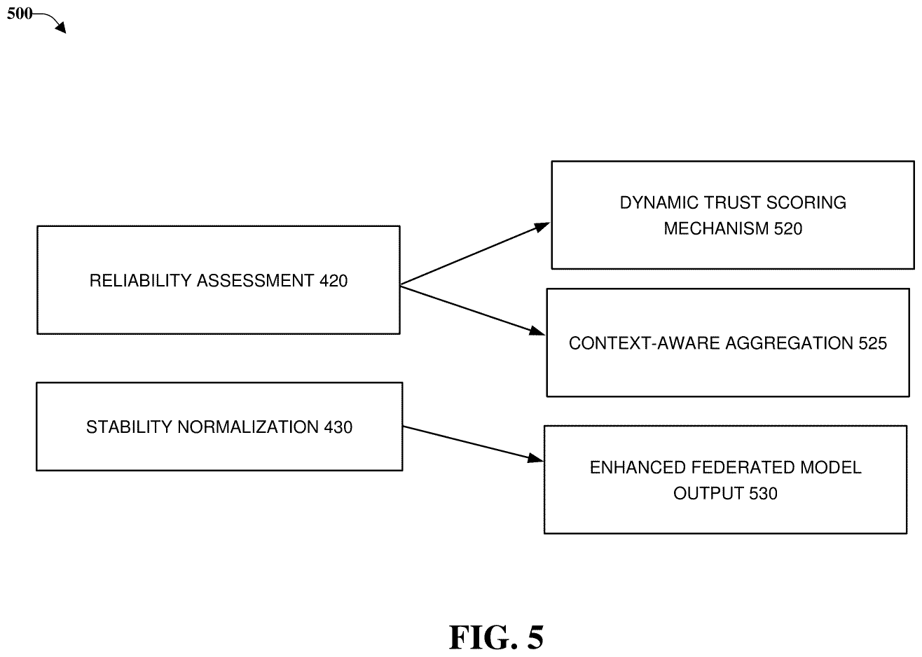

FIG. 3 includes a diagram that illustrates aspects of example system 300 that can facilitate adjusting a magnitude gradient of a weight update based on the source of the data, in accordance with one or more embodiments. For purposes of brevity, description of like elements and/or processes employed in other embodiments is omitted. System 300 includes elements 310, 320, 330, 340, and 350 that are described below with the descriptions of FIGS. 4-5 to illustrate different aspects of one or more embodiments. At 320, aspects of an integrity screening phase of embodiments are included, e.g., discussed in detail with FIG. 4 below. At 310 and 350, aspects of reliability assessment with dynamic trust scoring are provided, e.g., discussed in detail with FIG. 5 below. At 330 and 340, aspects of a stability normalization phase of embodiments are included, e.g., discussed in detail with FIG. 5 below.

FIG. 4 includes a diagram that illustrates aspects of example system 400 that can facilitate adjusting a magnitude gradient of a weight update based on the source of the data, in accordance with one or more embodiments. For purposes of brevity, description of like elements and/or processes employed in other embodiments is omitted. System 400 includes data sources 105A-C, integrity screening phase 410, reliability assessment phase 420, stability normalization phase 430, and trusted data source 450. In an implementation, to illustrate different examples, data sources 105A-C are decentralized and operating semi-independently. As discussed further below, in one or more embodiments, system 400 may provide a three-phase protocol for federated model aggregation that may mitigate risks associated with certain data sources by employing processes that include, but are not limited to integrity screening phase 410, reliability assessment phase 420, and stability normalization phase 430.

In one or more embodiments, at integrity screening phase 410, updates from data sources 105A-C may be filtered based on different trustworthiness criteria, e.g., consistency criteria, accuracy criteria, security criteria, and/or other similar factors. In one or more embodiments, integrity screening phase 410 may be used to filter out suspicious updates based on similarity to the local model, e.g., potentially reducing the risk of training a model based on erroneous and/or malicious updates.

In accordance with 320, In an implementation, a similarity value may correspond to a layer-wise cosine similarity between the local model update Δᵢ and each neighboring model update Δⱼ. For example, in some implementations, for each layer l in the model, the cosine similarity between the local model update Δ^{(l)} and the neighbor model update Δ^{(l)} may be determined by 320, where S^{(l)} represents the similarity score for layer l. The overall similarity score Sᵢⱼ between models Δᵢ and Δⱼ may then be obtained by averaging the layer-wise similarities. In one or more embodiments, threshold τ_{S} may be set to filter out updates with a low similarity score to other updates, e.g., updates currently being processed, and/or updates from historical data. Any model update Δⱼ with Sᵢⱼ<τ_{S} is considered potentially malicious and removed from further processing. This threshold is selected empirically, balancing security and inclusivity to retain benign updates while filtering out anomalies.

One or more embodiments may use this similarity analysis to improve security while not reducing the inclusivity of heterogeneous data sources, e.g., context-aware aggregation (also termed adaptation herein) may be used to dynamically adjust thresholds in response to environmental factors. By adjusting filtering thresholds (e.g., used to filter data by integrity screening phase 410), one or more embodiments, may improve the security and efficiency of data collected from diverse, decentralized, multicloud, and/or edge environments, e.g., improving the collection of genuinely diverse, benign data, while mitigating potential attacks from untrustworthy data sources. Stated differently, the adaptable threshold applied to the inclusion of data from data sources may facilitate inclusion of valid updates even when they differ, e.g., capturing beneficial changes to a model from training by diverse data, without compromising security.

FIG. 5 includes a diagram that illustrates aspects of example system 500 that can facilitate adjusting a magnitude gradient of a weight update based on the source of the data, in accordance with one or more embodiments. For purposes of brevity, description of like elements and/or processes employed in other embodiments is omitted. System 500 includes reliability assessment phase 420, stability normalization phase 430, dynamic trust scoring mechanism 520, context-aware aggregation 525, and enhanced federated model output 530.

In some implementations, at reliability assessment phase 420, a dynamic trust scoring mechanism 520 may assign adaptive trust scores to each of data sources 105A-C based on factors that include, but are not limited to, historical reliability of the data source, consistency of the data source, security of the source, likelihood that a data source nodes has been compromised, and/or other similar factors relevant to the trustworthiness of the data source. Based at least on the consideration of these factors, embodiments may utilize an adaptive, trust-based approach to training data collection that enhances the weight of consistent and reliable data sources, while minimizing the influence of erratic or potentially malicious data sources, e.g., improving model security and stability, reducing risks from rogue updates, and improving predictive accuracy and operational efficiency. In some embodiments, application of filtering criteria to evaluate data sources (and the filtering criteria applied) may be continuously updated based on historical performance patterns and current behavior of data sources 105A-C, e.g., improving performance of embodiments in changing contexts.

In embodiments, may also utilize a bootstrap validation mechanism that uses datasets of other data sources to evaluate updates generated from by an analyzed node, e.g., reliability of data source 105C may be evaluated based on data from data sources 105A-B. In addition, reliability assessment phase 420 may evaluate data source 105C based on trusted data source 450, e.g., a data source similar to data source 105C that has been previously assessed as being trustworthy. In an embodiment, the results of the bootstrap analysis may include a bootstrap loss value (lⱼ). In some embodiments, this bootstrap loss value may be continuously updated based on historical performance patterns and current behavior of data sources 105A-C. In an example, the continuous updating of loss values may be termed context-aware aggregation 525 of source data.

After calculating the bootstrap loss (lⱼ) for each update, at 510 one or more embodiments may determine a dynamic trust score Tⱼ based on the historical discrepancy between each node's performance and that of its neighbors, where d^{(r)} is the discrepancy in the r-th round, and α is a sensitivity coefficient. In an example implementation, comparing updates from data source 105A to data source 105B according to a similarity criterion may result in a level of similarity of the first weight value to the second weight value. This level of similarity may be used to evaluate one or both the data sources 105A-B. In an embodiment, this level of similarity may be assigned to a data source, e.g., by a manual remediation process.

Continuing the discussion of reliability assessment phase 420: once generated, the respective trust scores for updates from data sources 105A-C are then aggregated with an assignment of a gradient magnitude of weight updates from the respective data sources, e.g., a magnitude of change to the model during training, based on the weight update from a data source. As used herein gradient magnitude of weight updates may also be termed a weight contribution of an update, and parameter activations based on iterative adjustments.

In one or more embodiments, this aggregation process may provide security against adversarial attacks, e.g., potentially reducing the influence of malicious updates that could degrade the performance of a model or introduce backdoors. The aggregation process may further provide adaptivity to node reliability, e.g., by dynamically adjusting the weight of each node's update based on its historical reliability. The aggregation process may further dynamically provide consistency in circumstances with non-independent and identically distributed data.

For example, in an implementation, when a first trust score of data source 105A indicates a lower trust level than a second trust score of the data source 105B, based on the lower trust level of the first node, a weight contribution of an update from of data source 105A is generated to be less than the weight contribution of data source 105B.

At stability normalization phase 430, consistency of updates from data sources 105A-C may be maintained by normalizing model updates to ensure stability in the aggregated output and to mitigate the effects of any high-magnitude updates that may evade appropriate filtering by integrity screening phase 410 and/or a gradient magnitude adjustment by reliability assessment phase 420. In an implementation, normalization of the federated weight adjustments may be achieved by a layer by layer rescaling of the respective gradient magnitudes (also termed herein, a layer-wise normalization of the respective weight contributions).

For example, as shown at 330, for each node nⱼ with model update Δⱼ, one or more embodiments may determine the norm ∥Δⱼ∥ of the update. A local model norm ∥Δ_{local}∥ may be used as a reference, and a scaling factor ρⱼ may be determined to normalize the magnitude of neighbor model updates. Further, as shown at 350, pⱼ may be applied to model updates such that each model update does not exceed the magnitude of the local update, e.g., thereby controlling the influence of updates from nodes that might introduce disproportionately large changes, potentially due to stealthy adversarial behavior. After the normalization and magnitude adjustment, one or more embodiments may determine a normalized update \tilde{Δ}ⱼ as shown at 340. Based on the weighted and normalized updates, a globally aggregated model M_{global} may be determined.

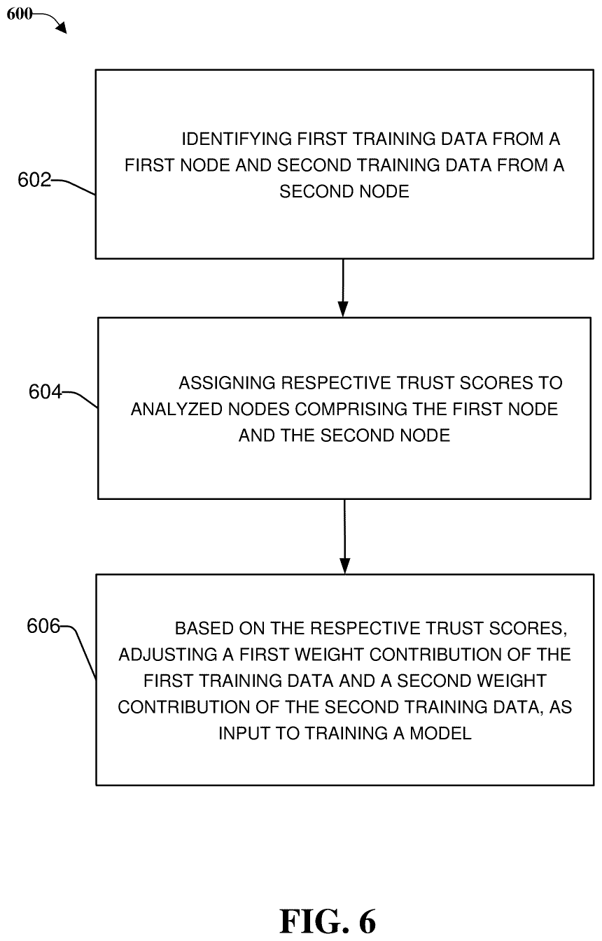

FIG. 6 depicts a flow diagram representing example operations of an example method 600 that can facilitate adjusting a magnitude gradient of a weight update based on the source of the data, in accordance with one or more embodiments. For purposes of brevity, description of like elements and/or processes employed in other embodiments is omitted.

In some examples, one or more embodiments of method 600 can be implemented by data component 122, scoring component 124, contribution component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, data component 122 of contribution adjustment equipment 150 can identify first training data from a first node and second training data from a second node. At 604 of method 600, scoring component 124 can assign respective trust scores to analyzed nodes comprising the first node and the second node; and. At 606 of method 600, contribution component 126 can, based on the respective trust scores, adjust a first weight contribution of the first training data and a second weight contribution of the second training data, as input to training a model.

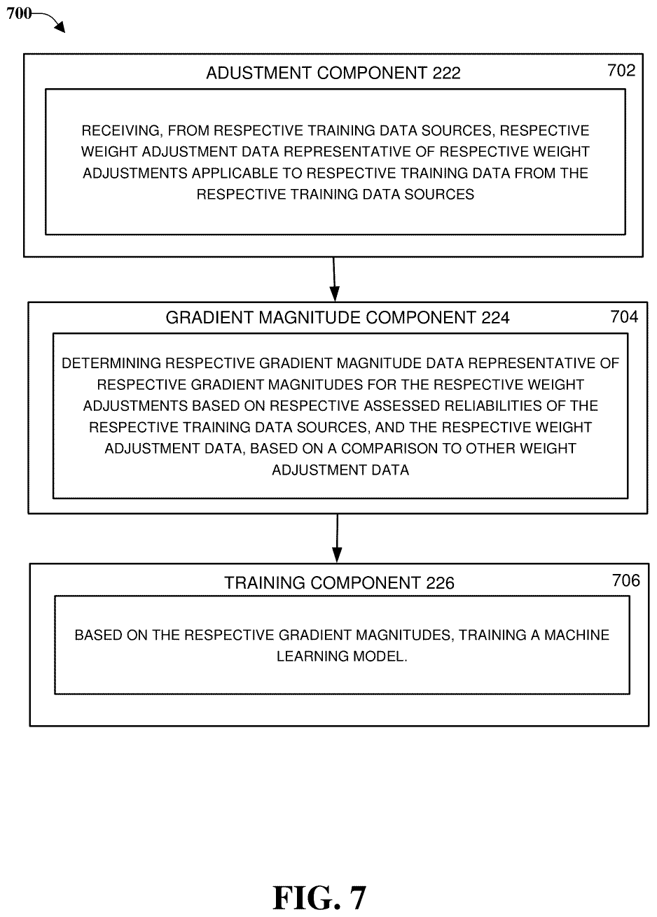

FIG. 7 depicts an example system 700 that can facilitate adjusting a magnitude gradient of a weight update based on the source of the data, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including adjustment component 222, gradient magnitude component 224, training component 226, and other components that can be used to implement aspects of system 700, as described herein, in accordance with one or more embodiments.

At 702 of FIG. 7, adjustment component 222 can receive, from respective training data sources, respective weight adjustment data representative of respective weight adjustments applicable to respective training data from the respective training data sources. At 704 of FIG. 7, gradient magnitude component 224 can determine respective gradient magnitude data representative of respective gradient magnitudes for the respective weight adjustments based on respective assessed reliabilities of the respective training data sources, and the respective weight adjustment data, based on a comparison to other weight adjustment data. At 706 of FIG. 7, training component 226 can, based on the respective gradient magnitudes, train a machine learning model.

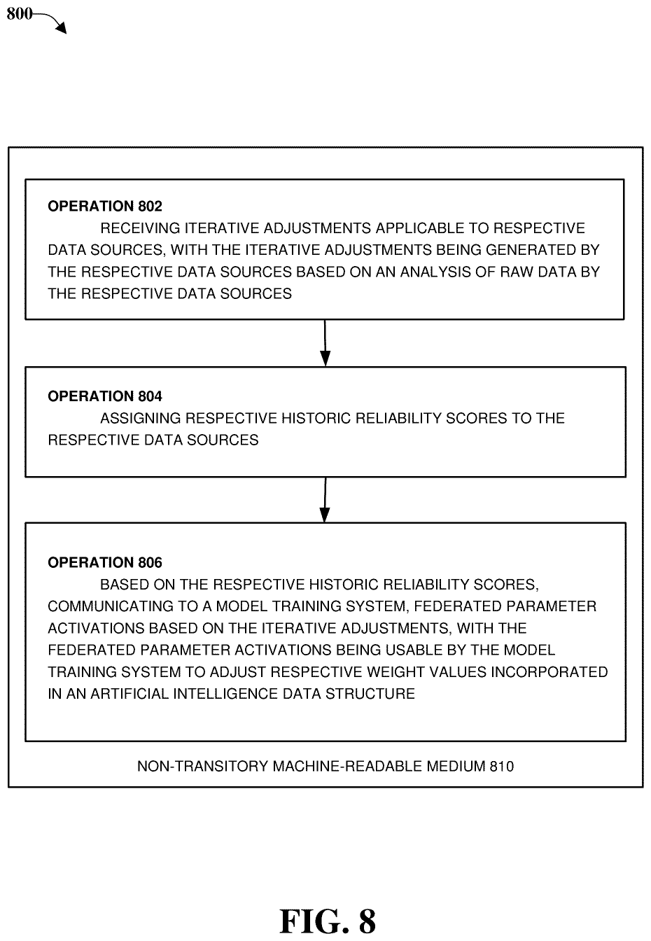

FIG. 8 depicts an example 800 non-transitory machine-readable medium 810 that can include executable instructions that, when executed by a processor of a system, can facilitate adjusting a magnitude gradient of a weight update based on the source of the data, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 that can receive iterative adjustments applicable to respective data sources, with the iterative adjustments being generated by the respective data sources based on an analysis of raw data by the respective data sources. Further, the operations may include based on the respective historic reliability scores, communicating to a model training system, federated parameter activations based on the iterative adjustments, wherein the federated parameter activations are usable by the model training system to adjust respective weight values incorporated in an artificial intelligence data structure. The operations may further include operation 804 which can assign respective historic reliability scores to the respective data sources. Further, the operations may include operation 806 which can, based on the respective historic reliability scores, communicating to a model training system, federated parameter activations based on the iterative adjustments, with the federated parameter activations being usable by the model training system to adjust respective weight values incorporated in an artificial intelligence data structure.

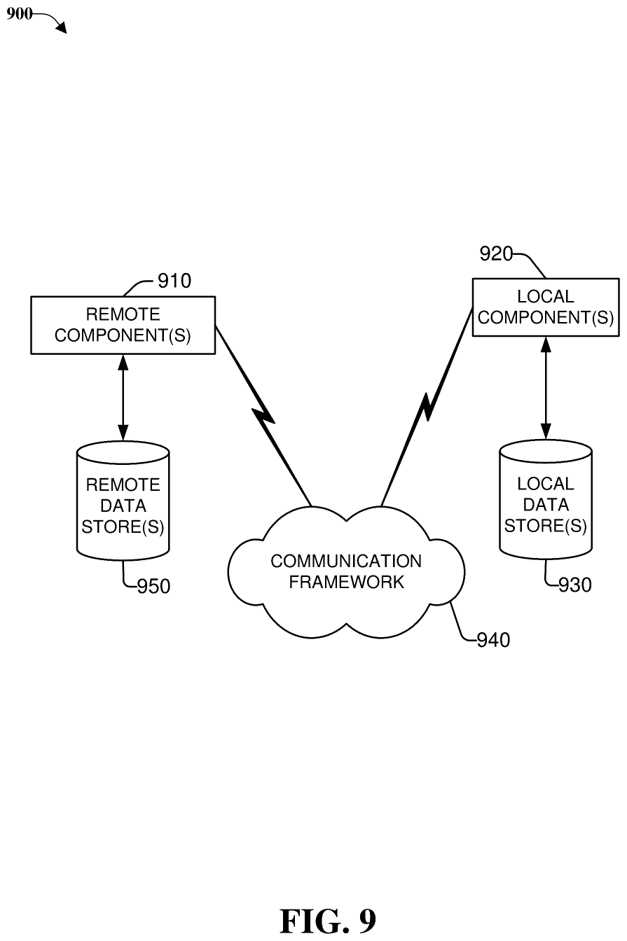

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips...), optical discs (e.g., CD, DVD...), smart cards, and flash memory devices (e.g., card, stick, key drive...). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2 ) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
identifying, by a system comprising one or more processors, first training data from a first node and second training data from a second node;
assigning, by the system, respective trust scores to analyzed nodes comprising the first node and the second node; and
based on the respective trust scores, adjusting, by the system, a first weight contribution of the first training data and a second weight contribution of the second training data, as input to training a model.

2. The method of claim 1, wherein a first trust score of the first node indicates a lower trust level than a second trust score of the second node, and wherein, based on the lower trust level of the first node, the first weight contribution of the first node is generated to be less than the second weight contribution of the second node.

3. The method of claim 1, wherein the assigning of the respective trust scores is based on respective historical reliabilities and respective consistencies of the analyzed nodes respectively determined according to a reliability criterion and a consistency criterion.

4. The method of claim 1, wherein the assigning of the respective trust scores is based on respective likelihoods of the analyzed nodes of being a compromised node.

5. The method of claim 1, wherein the assigning of the respective trust scores is based on respective comparisons of the analyzed nodes to a trusted node.

6. The method of claim 1, wherein the adjusting of the respective weight contributions comprises suppressing respective contributions of respective training data from the analyzed nodes based on the respective trust scores assigned to the analyzed nodes.

7. The method of claim 1, wherein the first training data comprises a first weight value determined by the first node, and wherein the first weight contribution of the first node comprises a magnitude of change to the model based on the first weight value.

8. The method of claim 7, further comprising:
comparing, by the system, the first weight value of the first node to a second weight value of the second node, resulting in a weight value comparison; and
further adjusting, by the system, the first weight contribution of the first training data based on the weight value comparison.

9. The method of claim 8, wherein the weight value comparison comprises a level of similarity of the first weight value to the second weight value determined according to a similarity criterion.

10. The method of claim 9, wherein the second node comprises a different trust score than the first node, wherein the first weight value and the second weight value comprise at least a threshold level of similarity, and wherein the further adjusting of the first weight contribution comprises changing the first weight contribution based on at least the threshold level of similarity and the different trust score of the second node.

11. The method of claim 9, further comprising:
determining, by the system, the level of similarity comprising obtaining the level of similarity from a manual remediation process.

12. The method of claim 1, wherein the adjusting of the respective weight contributions comprises adjusting the respective weight contributions based on a layer-wise normalization of the respective weight contributions.

13. The method of claim 1, wherein the assigning of the respective trust scores to the analyzed nodes comprises evaluating previously assigned trust scores of the analyzed nodes.

14. A federated training system, comprising:
at least one memory that stores computer executable instructions; and
at least one processor configured to process the computer executable instructions that, when executed by the at least one processor, facilitate performance of operations, comprising:
receiving, from respective training data sources, respective weight adjustment data representative of respective weight adjustments applicable to respective training data from the respective training data sources,
determining respective gradient magnitude data representative of respective gradient magnitudes for the respective weight adjustments based on respective assessed reliabilities of:
the respective training data sources, and
the respective weight adjustment data, based on a comparison to other weight adjustment data, and
based on the respective gradient magnitudes, training a machine learning model.

15. The federated training system of claim 14, wherein the operations further comprise:
performing a layer by layer rescaling of the respective gradient magnitudes.

16. The federated training system of claim 15, wherein the respective gradient magnitudes of the respective weight adjustment data are based on the respective assessed reliabilities of the respective training data sources.

17. The federated training system of claim 14, wherein the respective assessed reliabilities of the respective training data sources are based on a comparison of respective datasets of the training data sources based on a trust criterion, wherein the trust criterion was derived from analysis of a trusted data source.

18. A non-transitory machine-readable medium comprising executable instructions that, when executed by at least one processor, facilitate performance of operations, the operations comprising:
receiving iterative adjustments applicable to respective data sources, wherein the iterative adjustments were generated by the respective data sources based on an analysis of raw data by the respective data sources;
assigning respective historic reliability scores to the respective data sources; and
based on the respective historic reliability scores, communicating to a model training system, federated parameter activations based on the iterative adjustments, wherein the federated parameter activations are usable by the model training system to adjust respective weight values incorporated in an artificial intelligence data structure.

19. The non-transitory machine-readable medium of claim 18, wherein the federated parameter activations were determined based on:
the respective historic reliability scores of the respective data sources, and
respective measures of heterogeneity of the iterative adjustments.

20. The non-transitory machine-readable medium of claim 18, wherein the federated parameter activations were determined based on a normalization of the iterative adjustments.
